(19) United States
(12) Patent Application Publication
(10) Pub. No.: US 2015/0010399 A1
(43) Pub. Date: Jan. 8, 2015

(54) METHOD AND SYSTEM FOR DETECTION AND DETERRENCE OF FLYING ANIMALS AND PREVENTION OF COLLISIONS WITH WIND TURBINES

(71) Applicant: BIRDSVISION LTD., Yokneam Illit (IL)

(72) Inventors: Ofer Bahat, Zichron Yaakov (IL); Noah Satat, Misgav (IL)

(73) Assignee: BIRDSVISION LTD., Yokneam Illit (IL)

(21) Appl. No.: 14/375,627

(22) PCT Filed: Jan. 31, 2013
(86) PCT No.: PCT/IL2013/050088

§ 371 Date: Jul. 30, 2014

Related U.S. Application Data
(60) Provisional application No. 61/592,830, filed on Jan. 31, 2012.

(51) Int. Cl. F03D 11/00

(52) U.S. Cl. CPC F03D 11/0091
USPC 416/1; 416/61

(57) ABSTRACT

The disclosure presents systems, methods and computer program products relating to a wind farm. The presence of flying animals, such as birds, bats, and insects may be determined. Deterrence elements such as acoustic and/or visual deterrence elements may be activated in an attempt to deter animals whose presence was determined, and/or independently of a determination of animal presence. The rotation of the blades of one or more wind turbines may be slowed down and/or halted if collision is probable, in order to prevent flying animal casualties. Energy from deterrence elements may produce a predetermined tempo-spatial pattern of lights and/or sounds.

### CROSS-REFERENCE TO RELATED APPLICATIONS

This application claims the benefit of priority from U.S. Provisional Application No. 61/592,830, filed Jan. 31, 2012, which is hereby incorporated by reference herein.

### TECHNICAL FIELD

The disclosure relates to wind turbines.

### BACKGROUND

The risk to birds as well as other flying animals (e.g. bats, flying insects, etc.) is high at wind turbine infrastructure of a wind farm (including one or more turbines). Birds, bats and/or other flying animals may be unable to perceive the rotating blades of the wind turbines due to their high velocity, which may reach speeds well over 200 mph at blade's tip. Accordingly, a large number of flying animals fall victim to the rotating blades of wind turbines and consequently wind energy infrastructure is unable to function at full capacity due to risks to flying animals, including endangered species. Moreover, the fate of new wind generation projects is also at stake due to the potential risk to endangered flying animals.

### SUMMARY

In accordance with the presently disclosed subject matter, there is provided a system for detecting and deterring one or more flying animals from a wind farm, the system comprising at least one processor capable of: analyzing signals generated by one or more monitoring elements which monitor a monitored area, and determining that at least one flying animal to be deterred is present in the monitored area; activating one or more deterrence elements; and indicating to perform at least one of slowdown or halt of blade rotation of one or more wind turbines if probability of collision between the one or more wind turbines and one or more of the at least one flying animal is above a predetermined threshold.

In some embodiments, the system further comprises at least one memory storing program code including: program code for causing one or more of the at least one processor to analyze signals generated by one or more monitoring elements which monitor a monitored area, and for causing the at least one processor to determine that at least one flying animal to be deterred is present in the monitored area; program code for causing one or more of the at least one processor to activate one or more deterrence elements; and program code for causing one or more of the at least one processor to indicate to perform at least one of slowdown or halt of blade rotation of one or more wind turbines if a probability of collision between the one or more wind turbines and one or more of the at least one flying animal is above a predetermined threshold.

In some embodiments, the system further comprises: one or more monitoring elements capable of monitoring a monitored area and generating signals for analysis. In some examples of these embodiments, the one or more monitoring elements comprise any one or more of a CCD camera, a thermal imaging camera and radar. In some examples of these embodiments monitoring is based on one or more layers.

In some embodiments, the system further comprises: one or more deterrence elements, wherein each deterrence element is capable of generating or reflecting electromagnetic or pressure waves. In some examples of these embodiments, at least one of the one or more deterrence elements operates in pulses, and one or more of the at least one processor is capable of selecting for pulses of a deterrence element a frequency that is constant, that changes randomly, that is synchronized with blade rotation, or changes in a predetermined sequence.

In some examples of these embodiments, at least one of the one or more deterrence elements is capable of generating or reflecting electromagnetic or pressure waves independently of determination that at least one flying animal to be deterred is present in the monitored area.

In some examples of these embodiments, at least one of the one or more deterrence elements comprises at least one of: one or more Light Emitting Diodes, LEDs, placed along one or more wind turbines on at least one of tower, blades, hub, or nacelle, or one or more LEDs placed around at least one or more wind turbines. In some instances of these examples, the LEDs are embedded in a transparent coating on the surface of the blades. In some cases of these instances, the coating is made from polymethyl metacrilate (PMMA) or another transparent material.

In some examples of these embodiments, the one or more deterrence elements include at least one selected from a group comprising: LED, optic fiber, reflecting layer, light emitting color, transducer, or loudspeaker.

In some examples of these embodiments, for at least one of the one or more deterrence elements, one or more of the at least one processor is capable of selecting at least one of wavelength, wavelengths, frequency, frequencies, intensity, or intensities based on one or more of the least one flying animal.

In some examples of these embodiments, deterrence is based on one or more layers.

In some examples of these embodiments, there is a plurality of the one or more deterrence elements and wherein electromagnetic energy by at least part of the plurality of deterrence elements produces a predetermined tempo-spatial pattern of lights displayed on blades, tower, nacelle or any other part of one or more wind turbines. In some instances of these examples, the predetermined tempo-spatial pattern is an advertisement or decoration, or a part thereof.

In some embodiments, the system further comprises: one or more controllers capable of slowing down blade rotation or bringing the blades to full halt, upon indication by one or more of the at least one processor.

In some embodiments of the system, blade rotation is slowed down by changing the pitch of the blades.

In some embodiments of the system, blade rotation is slowed down or halted by activating turbine brakes.

In some embodiments of the system, one or more of the at least one processor is further capable of tracking movement of one or more of the at least one flying animal.

In some embodiments, the system further comprises: at least one transceiver.

In some examples of these embodiments, one or more of at least one processor is capable of communicating via one or more of the at least one transceiver with at least one other system at the wind farm. In some instances of these examples, capable of activating includes: one or more of the at least one processor capable of indicating to activate at least one deterrence element included in one or more of the at least one other system at the wind farm. In some instances of these examples, capable of indicating includes: one or more of the at least one processor capable of indicating to perform at least one of slowdown or halt of blade rotation of at least one other wind turbine associated with one or more of the at least one other system at the wind farm. In some instances of these examples, communication is via a radio frequency channel using a MESH protocol.

In some examples of these embodiments one or more of the at least one processor is capable of communicating with at least one control system.

In some embodiments of the system, deterrence elements associated with two or more wind turbines are activated simultaneously when presence of one or more flying animals is determined.

In some embodiments of the system, the system or a part thereof is adapted to obtain electrical power from at least one of wind turbine electricity, a dynamo component that generates electricity from rotation of the blades, an electric charger that generates electricity from movement of the rotating blades, or a solar panel.

In accordance with the presently disclosed subject matter, there is further provided a system for deterring flying animals from a wind turbine, comprising: a plurality of deterrence elements, each capable of generating or reflecting electromagnetic energy, wherein the electromagnetic energy from the deterrence elements produces a predetermined tempo-spatial pattern of lights displayed on or near the wind turbine.

In some embodiments, the system further comprises: at least one acoustic deterrence element, each capable of generating sound, wherein the tempo-spatial pattern includes sound.

In some embodiments of the system, the tempo-spatial pattern is displayed upon determination of a presence in a monitored area of one or more flying animals to be deterred.

In some embodiments of the system, the tempo-spatial pattern is displayed independently of determination of a presence in a monitored area of one or more flying animals to be deterred.

In some embodiments of the system, the tempo-spatial pattern is an advertisement or decoration or a part thereof.

In some embodiments of the system, at least one of the deterrence elements operates in pulses with a frequency synchronized with a blade rotation rate.

In accordance with the presently disclosed subject matter, there is further provided a method of detecting and deterring one or more flying animals from a wind farm, comprising: analyzing signals generated by one or more monitoring elements which monitor a monitored area, and determining that at least one flying animal to be deterred is present in the monitored area; activating one or more deterrence elements; and indicating to perform at least one of slowdown or halt of blade rotation of one or more wind turbines if a probability of collision between the one or more wind turbines and one or more of the at least one flying animal is above a predetermined threshold.

In some embodiments, the method further comprises: monitoring a monitored area and generating signals for analysis.

In some embodiments, the method further comprises: generating or reflecting electromagnetic or pressure waves.

In some embodiments, the method further comprises: selecting at least one of wavelength, wavelengths, frequency, frequencies, intensity, or intensities, for at least one of the one or more deterrence elements, based on one or more of the at least one flying animal.

In some embodiments of the method, at least one of the one or more deterrence elements operates in pulses, the method further comprising: selecting for pulses of a deterrent element a frequency that is constant, that changes randomly, that is synchronized with blade rotation, or changes in a predetermined sequence.

In some embodiments, the method further comprises: slowing down or halting blade rotation, upon indication.

In some embodiments, the method further comprises: tracking movement of one or more of the at least one flying animal.

In accordance with the presently disclosed subject matter, there is further provided a method of deterring flying animals from a wind turbine, comprising: providing a plurality of deterrence elements, each capable of generating or reflecting electromagnetic energy, wherein the electromagnetic energy from the deterrence elements produces a predetermined tempo-spatial pattern of lights displayed on or near the wind turbine.

In accordance with the presently disclosed subject matter, there is further provided a computer program product comprising a computer readable medium having computer readable program code embodied therein for detecting and deterring one or more flying animals from a wind farm, the computer program product comprising: computer readable program code for causing the computer to analyze signals generated by one or more monitoring elements which monitor a monitored area, and to determine that at least one flying animal to be deterred is present in the monitored area; computer readable program code for causing the computer to activate one or more deterrence elements; and computer readable program code for causing the computer to indicate to perform at least one of slowdown or halt of blade rotation of one or more wind turbines if a probability of collision between the one or more wind turbines and one or more of the at least one flying animal is above a predetermined threshold.

In some embodiments, the computer program product further comprises at least one selected from a group comprising: computer readable program code for causing the computer to select at least one of wavelength, wavelengths, frequency, frequencies, intensity, or intensities, for at least one of the one or more deterrence elements, based on one or more of the at least one flying animal; computer readable program code for causing the computer to select for pulses of at any one of the one or more deterrence elements, a frequency that is constant, that changes randomly, that is synchronized with blade rotation, or changes in a predetermined sequence; or computer readable program code for causing the computer to track movement of one or more of the at least one flying animal.

### BRIEF DESCRIPTION OF THE DRAWINGS

In order to understand the subject matter and to see how it may be carried out in practice, embodiments will now be described, by way of non-limiting example only, with reference to the accompanying drawings, in which:

FIG. 1 shows a schematic block diagram of a system for detecting and deterring flying animal(s) from a wind farm, in accordance with some embodiments of the presently disclosed subject matter;

FIG. 2 shows an example of placement of different visual deterrence elements on the hub and blades of a wind turbine, in accordance with some embodiments of the presently disclosed subject matter;

FIG. 3 shows an example of advertisement using visual deterrence elements on the blades of a turbine, in accordance with some embodiments of the presently disclosed subject matter;

FIG. 4 shows a possible installation of various monitoring elements and deterrence elements with respect to a wind turbine, in accordance with some embodiments of the presently disclosed subject matter;

FIG. 5 shows a flowchart of a method of detecting and deterring flying animal(s) from a wind farm, in accordance with some embodiments of the presently disclosed subject matter;

FIG. 6 shows a schematic block diagram of a system for reducing damage to colliding animal(s) at a wind farm, in accordance with some embodiments of the presently disclosed subject matter;

FIG. 7 shows schematically a plurality of systems at a wind farm, in accordance with some embodiments of the presently disclosed subject matter; and

FIG. 8 shows a schematic block diagram of a control station system, in accordance with some embodiments of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate identical or analogous elements.

### DETAILED DESCRIPTION OF EMBODIMENTS

Disclosed herein are some embodiments relating to systems, methods and computer program products relating to a wind farm. In some of these embodiments, the presence of flying animal(s), such as birds, bats, and insects may be determined. In some of these embodiments, deterrence element(s) such as acoustic and/or visual deterrence element(s) may be activated in an attempt to deter away animal(s) whose presence was determined, and/or independently of a determination of animal presence. For instance, the visibility of wind turbines to flying animals may be increased by clearly marking the presence and shape of the wind turbines, such as by marking the rotating blades, thereby enhancing the awareness of the animals to the wind turbine infrastructure, e.g. under any weather conditions, day and night. In some of these embodiments, the rotation of the blades of one or more wind turbines may be slowed down or even halted completely if collision is probable, in order to prevent flying animal casualty/ies due to collision with the wind turbine(s) and particularly with the rotating blades, and hence also to prevent possible damage to the wind turbine(s) as well.

In the following detailed description, numerous specific details are set forth in order to provide a thorough understanding of the subject matter. However, it will be understood by those skilled in the art that some embodiments of the subject matter may be practiced without these specific details. In other instances, well-known features, structures, characteristics, stages, methods, modules, elements, and systems have not been described in detail so as not to obscure the subject matter

It should be appreciated that certain features, structures, characteristics, stages, methods, modules, elements, and/or systems disclosed herein, which are, for clarity, described in the context of separate embodiments, may also be provided in combination in a single embodiment. Conversely, various features, structures, characteristics, stages, methods, modules, elements, and/or systems disclosed herein, which are, for brevity, described in the context of a single embodiment, may also be provided separately or in any suitable sub-combination.

Usage of the term “for example,” “such as”, “for instance”, “e.g.”, “possibly”, “it is possible” “optionally”, “say”, “one embodiment”, “one example”, “embodiments”, “examples”, “an embodiment”, “some embodiments”, “some other embodiments”, “certain embodiments”, “various embodiments”, “some examples”, “illustrated embodiments”, “another embodiment”, “another example”, “various examples”, “other embodiments”, “other examples”, “one instance”, “some instances”, “ another instance”, “other instances”, “one case”, “cases”, “some cases”, “another case”, “other cases”, or variants thereof means that a particular described feature, structure, characteristic, stage, method, module, element, or system is included in at least one non-limiting embodiment of the subject matter, but not necessarily included in all embodiments. The appearance of the same term does not necessarily refer to the same embodiment(s).

The term “illustrated embodiments” is used to direct the attention of the reader to one or more of the figures, but should not be construed as necessarily favoring any embodiment over any other.

Usage of conditional language, such as “may”, “can”, “could”, or variants thereof is intended to convey that one or more embodiments of the subject matter may include, while one or more other embodiments of the subject matter may not necessarily include, certain features, structures, characteristics, stages, methods, modules, elements, and/or systems. Thus such conditional language is not generally intended to imply that a particular described feature, structure, characteristic, stage, method, module, element, or system is necessarily included in all embodiments of the subject matter.

It should be appreciated that terms such as “analyzing”, “detecting”, “monitoring”, “activating”, “indicting”, “deterring”, “controlling”, “slowing”, “halting”, “generating”, “reflecting”, “selecting”, “changing”, “tracking”, “communicating”, “commanding”, “requesting”, “obtaining”, “displaying”, “producing”, “operating”, “synchronizing”, “determining”, “deciding”, or the like, may refer to the action(s) and/or process(es) of any combination of software, hardware and/or firmware, and/or may refer to function(s) performed by any element(s), system(s) and/or part(s) of system(s), disclosed herein. For example, one or more of these terms may refer in various embodiments to element(s) such as one or more processor(s), one or more monitoring element(s), one or more deterrence element(s), one or more input element(s), one or more display element(s), one or more controller(s), one or more transceiver(s), etc, may refer to one or more computer(s) (for instance including any of the above element(s)), and/or may refer to any system or any part thereof relating to a wind farm, etc.

As used herein, the term “memory” refers to any element for storage for the short and/or long term. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

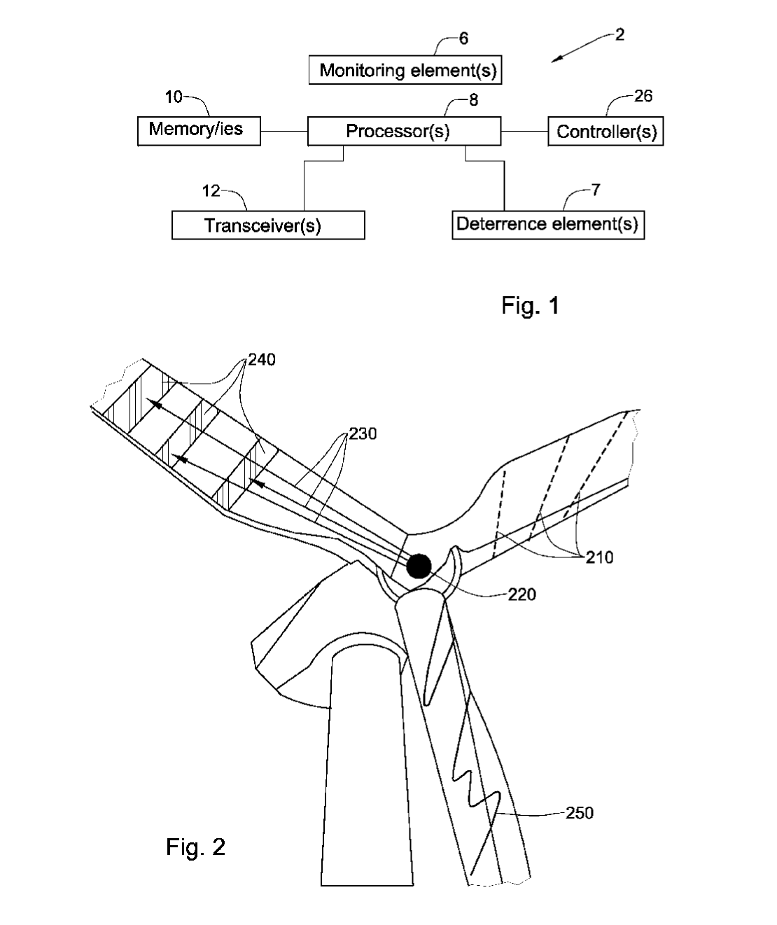

Referring now the drawings, FIG. 1 shows a schematic block diagram of a system 2 for detecting and deterring flying animal(s) from a wind farm, in accordance with some embodiments of the presently disclosed subject matter. Each system 2 may be associated with one or more wind turbines at a wind farm. However for simplicity of description it is assumed that each system 2 is associated with one wind turbine at a wind farm. There may be any number (>1) of systems 2 deployed at a wind farm, as required in any situation. System 2 may include one or more monitoring and detection element(s) (also referred to herein as monitoring element(s) for short) 6 and one or more deterrence element(s) 7. For simplicity's sake monitoring and detection element(s) 6 and deterrence element(s) 7 are illustrated and described separately but in some examples detection and deterrence functionality may be integrated in a single element. System 2 may further include the following elements: one or more processor(s) 8, one or more memory/ies 10, one or more transceiver(s) 12, and one or more controller(s) 26 for controlling physical parameters of a wind turbine, such as blade rotation. For simplicity's sake, processor 8, memory 10, transceiver 12 and controller 26 in a single system 2 are generally referred to below in the single form, but usage of the single form for any particular element should be understood to include embodiments where there is one of the particular element in a single system 2 and/or embodiments where there is a plurality of the particular element in a single system 2. Processor 8 may be, for instance, any type of processor such as a digital signal processor (DSP), a central processing unit (CPU), a microcontroller, a field programmable gate array (FPGA), an application specific integrated circuit (ASIC), etc. Memory 10 may or may not store program code, for instance depending on the type of processor. Additionally or alternatively, memory 10 may, for instance, store other data, such as operational data for the short and/or long term. In some embodiments, at least processor 8 and memory 10 may be comprised in and/or associated with a computer, but in other embodiments this may not necessarily be so. In some embodiments, at least part of system 2 may be specially constructed for the desired purposes.

Examples of any monitoring and detecting element 6 may include a Charge Coupled Device CCD camera, a thermal imaging camera, any other type of camera, radar, etc. Depending on the embodiment, if there is a plurality of monitoring elements 6 in system 2, the plurality may include the same type and/or different types of monitoring elements. Monitoring element(s) 6 may be configured to monitor a certain “monitored” area and provide signal(s) to processor 8 for analysis. Depending on the embodiment, processor 8 and any monitoring element 6 may be located in the same location or separated from one another with a wired and/or wireless connection for communication. In some embodiments the monitoring element(s) 6 may be configured to provide 360° coverage around the wind turbine, although any desired scanning angle may be used in accordance with the subject matter. The monitoring range may in some embodiments depend on the size and movement of the animals to be detected. For instance, if the animal is bigger, a particular monitoring element 6 may be capable of detecting the animal when it is farther away from that monitoring element 6 (i.e. there may be a larger monitoring range) than if the animal were smaller. If there is a plurality of monitoring elements 6 comprised in system 2, these monitoring elements 6 may be distributed in any appropriate fashion, or may be concentrated, depending on the embodiment. Depending on the embodiment, any monitoring element 6 may be included in a single system 2 or may be shared among (i.e. comprised in) a plurality of systems 2 (for instance providing signals to two or more processors 8 respectively in two or more systems 2).

Processor 8 may be configured to analyze the signal(s) provided by monitoring element(s) 6 in order to determine, if present, the presence of one or more flying animals to be deterred (e.g. any flying animal(s) or certain type(s) of flying animal(s)) in the monitored area. For instance, processor 8 may be configured to distinguish between object(s) to be deterred (e.g. flying animal(s), or certain type(s) of flying animal(s)), and other objects of no interest detected by monitoring element(s) 7, such as clouds, precipitation, foliage, flying animals of certain types that do not need to be deterred (if any), etc. Processor 8 may be configured to distinguish between various detected objects, for instance, based on the size, movement velocity and/or movement patterns of the detected objects, in order to be able to determine that flying animal(s) to be deterred is/are present. If it is determined by processor 8 that one or more flying animals to be deterred is/are present, the processor may be configured to activate one or more deterrence element(s) 7. Depending on the embodiment, processor 8 and any deterrence element 7 which may be activated by processor 8 may be located in the same location or may be separated from one another, for instance with a wired and/or wireless connection for communication (and/or activation may be via another system 2 as described in more detail below).

If there is a plurality of deterrence elements 7 comprised in system 2, these deterrence elements 7 may be distributed in any appropriate fashion, or may be concentrated, depending on the embodiment. Depending on the embodiment, any deterrence element 7 may be comprised in a single system 2 or may be shared among (i.e. comprised in) a plurality of systems 2. For example a particular deterrence element 7 which is shared, may be capable of communicating with two or more processors 8 respectively in two or more systems 2, for instance so that any of the two or more processors 8 respectively in the two or more systems 2 may communicate with the particular deterrence element 7 in order to activate the particular deterrence element 7.

Deterrence element(s) 7 may be configured to generate and/or reflect energy (e.g. electromagnetic waves and/or pressure waves) in an attempt to deter flying animals and thereby prevent collisions with wind turbines. Depending on the embodiment, at least one deterrence element(s) 7 may be configured to generate and/or reflect energy once it has been determined that a flying animal to be deterred is present in the monitored area, and/or at least one deterrence element(s) 7 may be configured to generate and/or reflect energy independently of such a determination, for example constantly or at certain times of the day and/or year. The deterring waves may or may not be noticeable to humans. The deterring waves may cause no damage to animals nor to humans. For any deterrence element 7 which is activated upon determination of animal presence, the lag between determination and activation may typically although not necessarily be a few milliseconds, but the lag is not bound by the subject matter. For any deterrence element 7 which is activated upon determination of animal presence, the deterrence element 7 may typically although not necessarily continue to generate and/or reflect energy for a time period of less than a minute, unless it has been determined that there is a large group of flying animals present, and in this case the deterrence element 7 may be active for a typically although not necessarily longer period of time. However, the time period is not bound by the subject matter.

For deterrence element(s) 7 activated upon determination that an animal to be deterred is present, the generated and/or reflected deterring waves should be noticeable to the flying animal(s) whose presence has been determined. For any deterrence element 7, in various embodiments, the intensity/ies, wavelength(s), frequency/ies and/or any other parameter(s) of the deterring waves may be selected based on the flying animal(s) whose presence has been determined; and/or the intensity/ies, wavelength(s), frequency/ies and/or any other parameter(s) used may be noticeable to any type of flying animal which may possibly intrude on the wind farm (including the animal whose presence has been determined). Depending on the embodiment, preference may be given to parameter value(s) which are noticeable by humans, preference may be given to parameter value(s) which not noticeable by humans, or no preference may be given to parameter value(s) based on whether or not noticeable to humans. For instance, assume that birds may perceive ultraviolet radiation of 300 to 400 nm, but bats may perceive the visible spectrum. Assuming that presence of only bird(s) was determined by processor 8, then in some embodiments, deterrence element(s) 7 may generate ultraviolet radiation because presence of a bird was determined, but in some other embodiment(s) deterrence element(s) 7 may (collectively) generate ultraviolet radiation as well as light in the visible spectrum, even though presence of only bird(s) was actually determined because bat(s) may sometimes intrude on the wind farm (and/or so that humans may see the radiation). Assume, for instance that birds hear frequencies in the infrasound part of the spectrum (0-20 Hz) but bats hear frequencies above the human audible spectrum (above 20 KHz). Assuming that presence of only bird(s) was determined by processor 8, then in some embodiments, deterrence element(s) 7 may generate infrasound because presence of a bird was determined, and in some other embodiment(s) deterrence element(s) 7 may (collectively) generate infrasound as well as sound above the human audible spectrum even though presence of only bird(s) was actually determined because bat(s) may sometimes intrude on the wind farm. In embodiments where it is preferred that humans also hear, audible sound may also be generated.

Depending on the embodiment, deterrence element(s) 7 may include one or more visual deterrence element(s) and/or one or more acoustic deterrence element(s).

With regard to electromagnetic waves, one or more of deterrence element(s) 7 may be termed visual deterrence element(s), in that the element(s) are configured to generate and/or reflect electromagnetic signals that may be visible at least to one or more types of flying animals. For instance, the electromagnetic signals may appear to animals as steady (i.e. continuous) light and/or flashing (i.e. pulses of) light which suddenly distresses and startles the animals, and deters them away. Light may be generated, for example, by one or more Light Emitting Diodes LEDs placed on and/or around the wind turbine, for example along and around the tower, blades, hub, and/or nacelle (gear box housing) of the wind turbine and/or around the wind turbine at certain location(s) and/or distance(s). In some embodiments, the LEDs may be placed in an array on all sides of the wind turbine so that the light may be visible to the animals from a distance and from all directions. The LEDs may be embedded, for instance, in a thin transparent coating on the surface of the blades that may not significantly increase the drag and other aerodynamic characteristics of the blades. The coating may be, for example, polymethyl metacrilate (PMMA) or any other transparent material. The LEDs may operate, for example, in the visible (to humans) part of the spectrum and/or in the ultraviolet part of the spectrum (300-400 nanometer), which is seen by birds but not by humans. Electromagnetic signals may additionally or alternatively be generated and/or reflected for example, by means of one or more laser beams which may be placed at one or more specific locations on the wind turbine and/or opposite to it, such as the tower, hub, nacelle and/or blades, and/or by using optic fibers, reflecting layers (i.e. reflective material), small scale light emitting colors and/or any other visual deterrence element(s) which may be concentrated or which may be distributed on the tower, hub, nacelle and/or blades of the wind turbine.

Refer to FIG. 2 which shows an example of placement of different visual deterrence elements 7 on the hub and blades of a wind turbine, in accordance with some embodiments of the presently disclosed subject matter.

FIG. 2 illustrates illuminated optic fibers 210, a laser source 220 whose laser beam direction 230 is as shown, reflective material 240, and illuminating LEDs and optic fibers 250. The distribution of visual deterrence elements and the types of elements shown in FIG. 2 are for the purpose of illustration only and in various embodiments, there may be one or more visual deterrence element(s) 7 of any type(s), and if there is a plurality of visual deterrence element(s) 7, the elements may be of one or more types. Additionally or alternatively, in some embodiments visual deterrence element(s) 7 may be distributed in a different manner than shown in FIG. 2, or concentrated.

The electromagnetic energy generated and/or reflected by at least part of visual deterrence element(s) 7 may in some embodiments produce a predetermined tempo-spatial pattern of light on a wind turbine, for instance on the blades, the tower, the nacelle and/or on any other part of the wind turbine. A pattern may additionally or alternatively be produced near the wind turbine, for instance on the ground near the wind turbine. A produced pattern may or may not be an advertisement and/or decoration, or a produced pattern may or may not be part of an advertisement and/or decoration. A produced pattern may or may not also include sound generated by one or more acoustic deterrence element(s). Depending on the embodiment, a pattern may be produced upon determination that a flying animal to be deterred is present in the monitored area, and/or may be produced independently of such a determination, for example constantly or at certain times of the day and/or year. In some embodiments, the electromagnetic energy generated and/or reflected by visual deterrence element(s) 7 may not produce a tempo-spatial pattern, and may instead appear as a random distribution or concentrated.

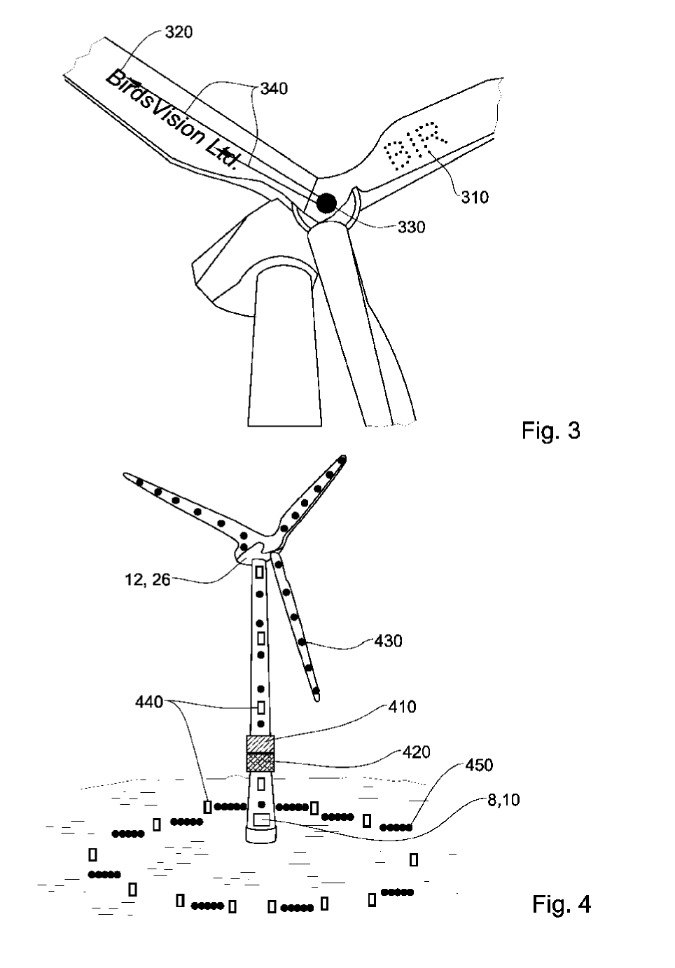

Refer to FIG. 3 which shows an example of advertisement using visual deterrence elements on the blades of a wind turbine, in accordance with some embodiments of the presently disclosed subject matter. In FIG. 3, LED's 310 form the letters “BIR”. Reflective material 320 in the form of the letters “BirdsVision Ltd.” reflect light generated by a laser source 330 whose laser beam direction 340 is in the direction of the reflective material. In embodiments where a pattern is produced, the form and content of a pattern that is produced is not bound by the advertisement shown in FIG. 3 and may be any appropriate pattern.

Depending on the embodiment, the visual deterrence for any visual deterrence element 7 may be activated upon determination that animal(s) to be deterred is/are present in the monitored area, and/or independently, for example constantly or at certain times of the day and/or year. Upon determination that an animal to be deterred is present and/or independently (depending on the embodiment), any visual deterrence element 7 may be operated continuously and/or may be operated in pulses. For any visual deterrence element 7 operated in pulses, the frequency of the pulses may be determined (e.g. by processor 8) so that the frequency is constant, the frequency changes randomly, the frequency is synchronized with the rotation of the blades, or the frequency changes in a predetermined sequence. Random change in frequency may be achieved, for instance by way of random modulation. For instance, a predetermined sequence may be a predominantly designed sequence (e.g. determined by processor 8). Synchronization between visual deterrence elements 7 on the blades and the rotation rate of the blades may, for instance, not only increase the visibility of the blades, but may also, for instance, facilitate the use of the rotating blades to produce a desired tempo-spatial pattern of light in embodiments where production of a pattern is desired. Different visual deterrence element(s) 7 which operate in pulses may or may not operate at the same frequency or frequencies.

It is noted that a higher intensity electromagnetic signal, and/or a flashing electromagnetic signal may possibly allow the light to be visible to flying animals, day and night, and under all weather conditions. However the subject matter is not bound by high intensity flashing signals, and in some embodiments, steady and/or lower intensity signals may be used additionally or alternatively. In some embodiments, the visual deterrence may also be used to enhance the visibility of the wind turbines to approaching aircraft in order to prevent collisions (e.g. in bad weather).

With regard to pressure waves, one or more of deterrence element(s) 7 may be termed acoustic deterrence element(s) in that the element(s) are configured to generate acoustic signals that may be heard at least by one or more types of flying animals. For instance, acoustic deterrence element(s) 7 may be used to generate loud sounds which suddenly distress and startle the animals and deter them away. The sound (loud or otherwise) may be produced, for example, by one or more transducer(s), loudspeaker(s) and/or other acoustic deterrence element(s) placed on and/or around the wind turbine, for example along and around the tower, blades, hub, and/or nacelle of the wind turbine, and/or around the wind turbine at certain location(s) and/or distance(s). Transducers may in some embodiments be placed in a distribution on all sides of the wind turbine such that the sound they produce may be heard by animals from a distance and in all directions. The frequency/ies of the sound may be, for instance, in the human audible part of the spectrum (20 Hz-20 KHz), in the infrasound part of the spectrum (0-20 Hz which may be heard for example by birds but not by humans) and/or above the human audible spectrum (above 20 KHz), which may be heard for example by bats, but not by humans.

Depending on the embodiment, the acoustic deterrence of any acoustic deterrence element 7 may be activated upon determination of presence of animal(s) to be deterred and/or independently, for example constantly or at certain times of the day and/or year. Upon determination of presence of an animal to be deterred and/or independently (depending on the embodiment), any acoustic deterrence element 7 may be operated continuously and/or may be operated in pulses. For any deterrence element 7 operated in pulses, the frequency of the pulses may be determined (e.g. by processor 8) so that the frequency is constant, the frequency changes randomly, the frequency is synchronized with the rotation of the blades, or the frequency changes in a predetermined sequence. Random change in frequency may be achieved, for instance by way of random modulation. For instance, a predetermined sequence may be a predominantly designed sequence (e.g. determined by processor 8). Different acoustic deterrence element(s) 7 which operate in pulses may or may not operate at the same frequency or frequencies.

It is noted that a higher intensity acoustic signal and/or a pulsing acoustic signal may possibly allow the sound to be heard by flying animals, day and night, and under all weather conditions. However the subject matter is not bound by high intensity pulsing acoustic signals, and in some embodiments continuous and/or lower intensity acoustic signals may be used additionally or alternatively.

Processor 8 may be configured to communicate with controller 26. Depending on the embodiment, processor 8 and controller 26 may be located in the same location or separated from one another with a wired and/or wireless connection for communication. Typically although not necessarily controller 26 may be in the nacelle of a wind turbine and processor 8 may be located further down the tower closer to the ground. Typically although not necessarily, besides controller 26 the nacelle may include means to slow down the rotation of the blades, such as a motor to change the pitch of the blades so as to increase the drag on the blades and/or brakes to slow down and/or completely halt the rotation.

Processor 8 may be configured to indicate to perform at least one of slowdown or halt of blade rotation of one or more wind turbines, under certain condition(s). For instance, condition(s) may include probability of collision of flying animal(s) with wind turbine(s) above a predetermined threshold (which may be any percentage appropriate for the particular wind farm). Depending on the embodiment, processor 8 may be configured to indicate slowdown and/or to halt to controller 26 in the same system 2 as processor 8 and/or to controller(s) 26 in other system(s) 2 or 3 as will be described in more detail below. Any controller 26 may be configured to perform a slowdown of the rotation of the blades, for example by way of a motor for changing the pitch and/or by way of brakes. Additionally or alternatively, any controller 26 may be configured to perform a halt of the rotation of the blades by way of the brakes. Typically although not necessarily, from the time processor 8 indicates to perform at least one of slowdown or halt, it may take between 5 to 10 seconds until the blade rotation is slowed down, and/or 10-20 seconds until the blades are completely halted. In some embodiments, slowing down the rotation of the blades may first include changing the pitch of the blades to increase the drag on the blades, and/or activating the brakes. Then, if needed, the brakes may be activated to completely halt the movement of the blades.

Depending on the embodiment, the detection and/or deterrence of any system 2 may be based on one or more geographic layers. For example, in some embodiments, system 2 may operate with three geographic layers. The first and outer layer may comprise one or more cameras, radars and/or other monitoring element(s) that detect approaching animals, as well as one or more visual and/or acoustic deterrence elements which may be placed at a distance from the wind turbine (e.g. 600-1,000 m away from the wind turbine). The second layer may comprise one or more cameras, radars and/or other monitoring element(s) that detect approaching animals, as well as one or more visual and/or acoustic deterrence elements which may be placed closer to the wind turbine (e.g. 300-600 m). The third layer may comprise one or more cameras, radars and/or other monitoring element(s) that detect approaching animals, as well as one or more visual and/or acoustic deterrence elements which may be placed on the wind turbine itself. In this example, if the presence of a flying animal to be deterred is determined while the flying animal has not passed the outer layer, processor 8 may activate deterrence element(s) 7 in the outer layer in an attempt to deter the animal away and prevent a collision with a wind turbine. If the animal continues to move closer to the wind turbine, processor 8 may activate the second layer of deterrence in an attempt to deter the animal away and prevent a collision with a wind turbine. If the animal continues to a closer range to the wind turbine (e.g. 0-300 m), processor 8 may activate the deterrence element(s) 7 on the wind turbine itself. In this example, if the flying animal is still not deterred and there is a probability of collision above a predetermined threshold, processor 8 may indicate (e.g. send a message) to controller(s) 26 to slow down and/or halt the blades' rotation. For instance, processor 8 may decide independently to indicate slowdown and/or halting, may request permission to indicate slowdown and/or halting, or may be commanded to indicate slowdown and/or halting as described in more detail below. The predetermined threshold may be any percentage appropriate for the particular wind farm, for instance 10% probability, 90% probability, etc.

Additionally or alternatively to geographic layer(s), the detection and/or deterrence of system 2 may be based on one type of monitoring element 6 and/or one type of deterrence element 7, and/or may be based on a plurality of types of monitoring element(s) 6 and/or deterrence element(s) 7 with different capabilities operating in parallel and/or at different times. For instance, a radar and a camera may possibly have different monitoring capabilities which may be exploited in any system 2 which uses radar(s) and camera(s) in parallel and/or at different times. Different types of visual and/or acoustic deterrence element(s), for instance, may possibly have different deterrence capabilities which may be exploited in any system 2 which uses the different types in parallel and/or at different times.

FIG. 4 shows a possible installation of various monitoring elements 6 and deterrence elements 7 with respect to a wind turbine, in accordance with some embodiments of the currently disclosed subject matter. The installation shows monitoring element(s) of a radar 410 and a CCD or thermal camera 420. Also shown installed are visual deterrence element(s) of LEDs 430 (for the purpose of illustration shown as a circular shape), LED arrays 450 (for the purpose of illustration shown as connected circular shapes), and acoustic deterrence element(s) of acoustic transducer(s) 440 (for the purpose of illustration shown as a narrow rectangular shape). The installation demonstrates that element(s) 6 and 7 may be placed on and/or around a wind turbine. Also shown installed are controller 26 and transceiver 12 in the nacelle, and processor 8 and memory 10 in a location closer to the ground. In other embodiments, transceiver 12 may be anywhere else on the wind turbine (e.g. closer to the ground) or not on the wind turbine, and/or processor 8 and/or memory 10 may be anywhere else on the wind turbine or not on the wind turbine. The subject matter is not bound by the installation shown in FIG. 4 or by any other particular installation and depending on the embodiment any suitable installation may be used.

System 2 or any part thereof may in certain embodiments obtain electricity from the wind turbine electricity. In addition or alternatively, system 2 or any part thereof may in certain embodiments obtain electricity from other sources such as solar panel(s) (e.g. on the turbine's tower(s)), a dynamo component that generates electricity from the rotation of the blades around the central hub, and/or an electric charger that generates electricity from the movement of the rotating blades themselves. However the subject matter is not bound by any particular source(s) of electricity and any appropriate source(s) of electricity may be used.

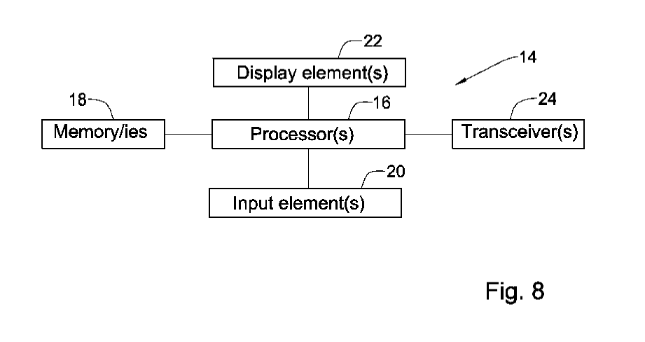

Depending on the embodiment, processor 8 may or may not be configured to track movement of a flying animal whose presence was determined. Based on the tracking, processor 8 may be able to calculate one or more parameters regarding the animal such as the flying altitude of the animal, the speed of the animal, the flight direction of the animal, etc. The tracking may assist processor 8 in making decision(s), for instance whether or not to activate deterrence element(s) 7, which deterrence element(s) 7, if any, to activate, whether or not to indicate to slow down the rotation of the blades and/or to bring the rotation to a full halt, which turbine(s) blade(s) rotation, if any, should be slowed down and/or halted, and/or whether or not to communicate with other system(s) 2 and/or 3 (see FIG. 6), with control system(s) 14 (see FIG. 8), and/or with any higher level control system as discussed in more detail below, regarding the animal whose presence was determined.

Any system 2 may or may not include transceiver 12. In embodiments with transceiver 12, transceiver 12 may enable system 2 to communicate with one or more system(s) relating to the wind-farm such as system(s) 2, 3, 14 and/or higher level control system(s). For example, depending on the embodiment, transceiver 12 may enable system 2 to communicate with control system(s) 14 (and/or with any higher level control system), or may enable system 2 to communicate with control system(s) 14 (and/or with any higher level control system), with other system(s) 2 associated with other wind turbine(s) at the wind farm, and/or with other system(s) 3 at the wind farm (if any). For instance for particular system 2 (which may be any system 2), particular processor 8 may be configured to transmit operational data (e.g. stored in memory 10) via particular transceiver 12 to control system 14 (and/or any higher level control system), and/or may be configured to receive commands and/or other data via particular transceiver 12 from control system 14 (and/or from any higher level control system). Additionally or alternatively, for instance, particular processor 8 may be configured to communicate with one or more other systems 2 via respective transceivers 12 in order that the other system(s)' deterrence elements 7 be activated, for instance by indicating (e.g. requesting and/or commanding) to the other processor(s) 8 to activate their respective deterrence element(s) 7. Additionally or alternatively, for instance particular processor 8 may be configured to communicate with one or more other system(s) 2 and/or 3 via respective transceivers 12 in order that blade rotation be slowed down and/or halted, for instance by indicating (e.g. requesting and/or commanding processor(s) 8 in other system(s) 2, and/or commanding controller(s) 26 in other system(s) 2 and/or in system(s) 3) to slow down blade rotation and/or bring the turbine(s) to a full halt. Additionally or alternatively, particular system 2 (e.g. particular processor 8 and/or particular controller 26) may be configured to receive communication(s) from other system(s) 2 via respective transceivers regarding activation of deterrence element(s) in particular system 2, slowing down blade rotation, and/or halting blade rotation. Particular system 2 may additionally or alternatively communicate with one or more system(s) 2, 3, 14 and/or any higher level control system, for any other reason(s).

The subject matter does not limit the channel(s) of communication between any system 2 and other system(s) 2 at a wind farm, between any system 2 and any system 3, if any, at a wind farm, between any system 2 and control system 14, and/or between any system 2 and any higher level control system. However, for the sake of further illustration to the reader, some examples are now provided. Communication among transceivers of various system(s) 2 and/or 3 may be, for example, via a radiofrequency (RF) communication channel, for instance using a MESH protocol, and/or for example via optical fiber. Communication of any system 2 and/or 3 with control system 14 may be, for example via a radiofrequency (RF) communication channel, for example using a MESH protocol, and/or for example via cellular, optical fiber, satellite, etc. Communication of any system 2 and/or 3 with any higher level control system may be for example via control system 14.

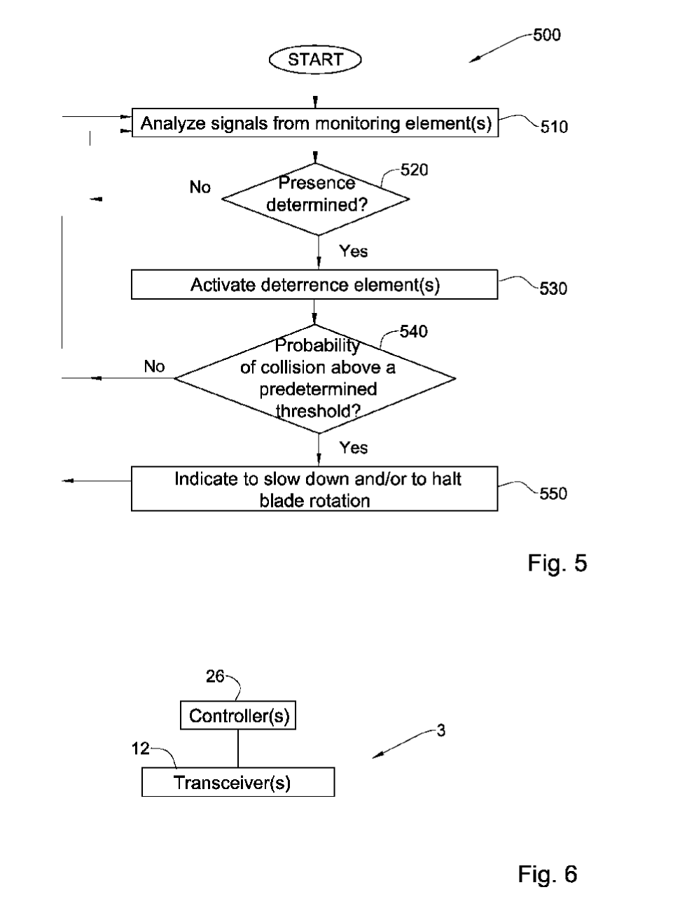

FIG. 5 shows an example of a flowchart of a method 500 of deterring flying animal(s) from a wind farm, in accordance with some embodiments of the presently disclosed subject matter. Method 500 may be performed by any system(s) relating to a wind farm such as system(s) 2, 3 14, and/or higher level control system(s). For simplicity of description it is assumed that at least part of method 500 is performed by processor 8 of system 2 (which may be any system 2), but in some embodiments, any stage of method 500 may be additionally or alternatively performed by any element(s) in any system(s) 2, 3, 14 and/or higher level relating to a wind farm.

In the illustrated embodiments in stage 510, signals generated by monitoring element(s) 6 which monitor a monitored area may be analyzed, for instance by processor 8.

In the illustrated embodiments in stage 520, if presence in the monitored area of at least one flying animal to be deterred is determined, for instance by processor 8, then method 500 may proceed to stage 530. Otherwise, in the illustrated embodiments, method 500 may return to stage 510. Depending on the embodiment, flying animals to be deterred may be any flying animals or flying animals of certain type(s).

In some embodiments, if it was determined that flying animal(s) to be deterred is/are present, movement of the animal(s) may be tracked, for instance by processor 8.

In the illustrated embodiments in stage 530, deterrence element(s) 7 may be activated, for instance by processor 8.

In embodiments with tracking, the activation of the deterrence element(s) may occur before, after and/or may overlap in time with the tracking.

Assuming embodiments with activation by processor 8, the activated deterrence element(s) 7 may be associated with at least one of the same wind turbine(s) as processor 8 (i.e. part of the same system 2), may be associated with other wind turbine(s) (i.e. part of different system(s) 2), or may be associated with at least one of the same wind turbine and at least one other wind turbine (i.e. shared by the same system 2 and by different system(s) 2). For instance, processor 8 may communicate via transceiver 12 to indicate to processor(s) 8 associated with other wind turbine(s) to activate deterrence element(s) associated with the other wind turbine(s). Depending on the embodiment, processor(s) 8 associated with the other wind turbine(s) which receive such an indication may or may not be able to override the indication so that in some embodiments associated deterrence element(s) 7 may not necessarily be activated. For instance, in some embodiments, the indication may be a request and may be overridden whereas in other embodiments the indication may be a command which may not be overridden.

In some embodiments, wavelength(s), frequency/ies, intensity/ies and/or any other parameter(s) for operation of the activated deterrence element(s) 7 may be selected, for instance by processor 8. For instance, the parameter(s) may be selected depending on which type(s) of flying animal(s) was/were determined to be present, may be selected in order to deter any type of flying animal which may approach the monitored area, even if presence is not currently determined, and/or may be selected in order to be noticeable or not noticeable to humans.

In some embodiments, frequency/ies of pulses for deterrence element(s) 7 which operate in pulses may be selected—e.g. constant, randomly changing, synchronized with blade rotation, and/or changing in a predetermined sequence, for instance by processor 8.

Assuming activation of deterrence element(s) 7 by processor 8, in some embodiments, processor 8 may decide to activate independently, whereas in other embodiments, the decision to activate may not be decided upon independently. For example, processor 8 may request permission from control system(s) 14 and/or from any higher level control system, prior to activating, or may be commanded to activate by control system(s) 14 and/or any higher level control system.

In the illustrated embodiments in stage 540, it may be determined, for instance by processor 8, if the probability of collision between the flying animal(s) whose presence was determined and any wind turbine(s) is above a predetermined threshold. If no, then in the illustrated embodiments, method 500 may iterate to stage 510. If yes, then in the illustrated embodiments, method 500 may continue to stage 550.

In the illustrated embodiments, in stage 550 slowdown of blade rotation and/or bringing the blades to a full halt for that/those wind turbine(s) may be indicated, for instance by processor 8.

Depending on the embodiment, any of stages 540 and 550 may occur before and/or after stage 530, and/or any of stages 540 and 550 may overlap in time with stage 530.

Assuming indication by processor 8, then depending on the embodiment, processor 8 may indicate to controller(s) 26 associated with the same wind turbine(s) as processor 8 (i.e. included in same system 2) for which there is probability of collision above a predetermined threshold, and/or to processor(s) 8 and/or controllers(s) 26 associated with other wind turbine(s) (i.e. included in other system(s) 2 and/or in system(s) 3) for which there is probability of collision above a predetermined threshold. For instance, processor 8 may communicate with other system(s) 2 and/or with system(s) 3 via transceiver 12. Depending on the embodiment, if processor 8 indicates to another system 2, the processor 8 of the other system 2 may or may not be able to override the indication, so that blade rotation for the other system 2 in some embodiments may not necessarily be slowed down and/or halted. For instance, in some embodiments, the indication may be a request and may be overridden whereas in other embodiments the indication may be a command which may not be overridden.

Assuming indication by processor 8, in some embodiments, processor 8 may decide to indicate independently, whereas in other embodiments, the decision to indicate may not be decided upon independently. For example, processor 8 may request permission from control system(s) 14 and/or from any higher level control system, prior to indicating slowdown and/or halting.

In some embodiments, instead of processor 8 determining that the probability is above a predetermined threshold, processor 8 may receive a command from control system(s) 14 and/or from any higher level control system to indicate to slow down and/or to halt because the probability is above a predetermined threshold.

In some embodiments, system 2 (e.g. via transceiver 12) may communicate with control system(s) 14 (and/or with any higher level control system), to transmit operational data such as data regarding flying animal(s) whose presence was determined (e.g. tracking data), data regarding operation and/or status of system 2, data regarding potential collision(s) between flying animal(s) and wind turbine(s), data regarding actual collision(s) between flying animals and wind turbine(s), data regarding operation of monitoring element(s) 6 and/or deterrence element(s) 7, etc. System 2 (e.g. via transceiver 12) may in some embodiments receive communication from control system 14 (and/or from any higher level control system) such as commands, updated program code and/or any other data. System 2 (e.g. via transceiver 12) may in some embodiments communicate with other system(s) 2 and/or system(s) 3, for instance transmitting and/or receiving data such as indications (e.g. relating to deterrence activation, slowdown and/or halting of blade rotation. etc), operational data, etc. The communication between system 2 and control system(s) 14 (and/or with any higher level control system) and/or the communication between system 2 and other system(s) 2 and/or 3 may occur periodically, continuously, and/or as needed depending on the embodiment.

As mentioned above, in some embodiments one or more of the stages of method 400 may be performed by any control system 14, independently or in cooperation with any system(s) 2 and/or 3. For instance, in some of these embodiments any system 14 (e.g. processor(s) 16) may do any of the following: may analyze signals from monitoring element(s), may determine that one or more animal(s) to be deterred is/are present, may track animals, may activate (or command activation) of deterrence element(s), may determine wavelength(s), frequency/ies, intensity/ies, other parameter(s), may determine whether pulse frequency/ies may be constant, change randomly, be synchronized with blade rotation and/or change in a predetermined sequence, may determine probability of collision, and/or may indicate to slow down and/or to halt blade rotation, etc.

Alternatively to the embodiments shown in FIG. 5 method 500 may in some other embodiments include more, fewer and/or different stages than illustrated in FIG. 5.

In various embodiments, there may be zero or more system(s) 3 for reducing damage to colliding animal(s) at a wind farm, each of which may be associated with one or more wind turbines. For simplicity of description, it is assumed that each system 3 is associated with one wind turbine. FIG. 6 shows a schematic block diagram of system 3 for reducing damage to colliding animal(s) at a wind farm, in accordance with some embodiments of the currently disclosed subject matter. Any system 3 may include the following elements: one or more controller(s) 26 and one or more transceiver(s) 12. For simplicity's sake, transceiver 12 and controller 26 in a single system 3 are generally referred to herein in the single form, but usage of the single form for any particular element should be understood to include embodiments where there is one of the particular element in a single system 3 and/or embodiments where there is a plurality of the particular element in a single system 3. Such a system may be appropriate, for example, for a particular wind turbine in close proximity to another wind turbine associated with a (neighboring) system 2, so that the monitoring element(s) 6 and deterrence element(s) 7 of system 2 may also inherently monitor and deter for the particular wind turbine. In this example, it is assumed that if the probability of collision with the particular wind turbine is above a predetermined threshold, processor 8 of neighboring system 2 may indicate to controller 26 of particular system 3 via respective transceivers 12 to slow down and/or halt the wind turbine. In other embodiments, no wind turbine at a wind farm may be associated with a system such as system 3.

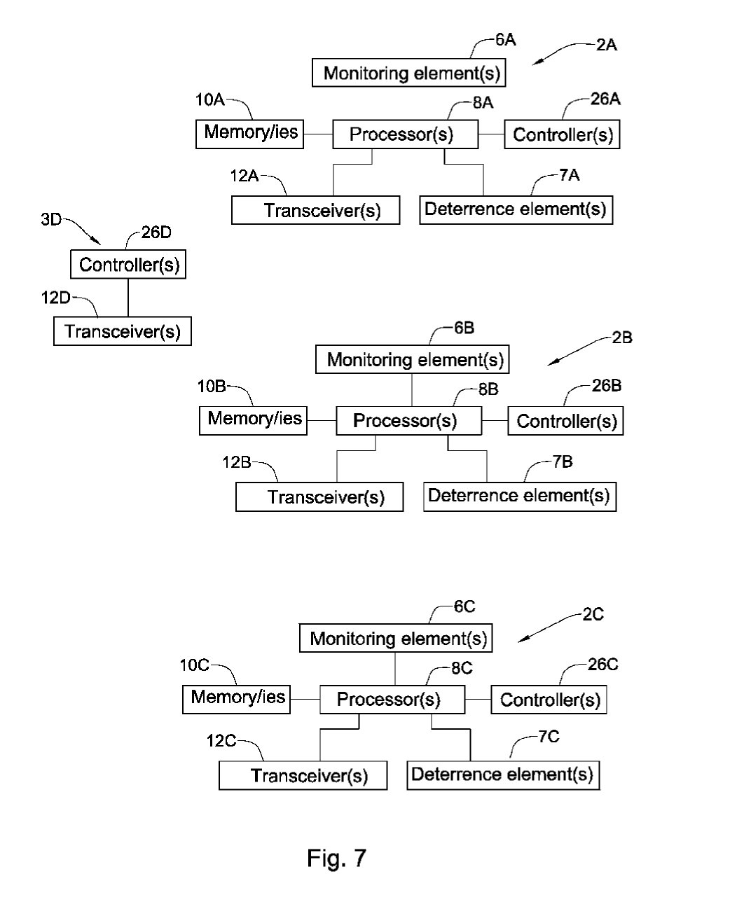

FIG. 7 shows a schematic block diagram of a plurality of systems 2 and 3 at a wind farm, in accordance with some embodiments of the presently disclosed subject matter. In this figures three systems 2 are shown (labeled 2A, 2B, 2C), and one system 3 is shown (labeled 3D). However this just an example, and a particular wind farm may include any number (≧1) of system(s) 2, and may include zero or more system(s) 3.

Depending on the circumstances, deterrence element(s) associated with two or more wind turbines at a wind farm may or may not be activated simultaneously. In some embodiments, simultaneous activation may be deployed when for instance a large number of flying animals approaches a wind farm. Simultaneous activation at several wind turbines may in some embodiments increase the effect of the visual and acoustic deterrence on the animals.

In some embodiments, there may be one or more wind turbine(s) at a wind farm which is associated with neither system 2 nor 3 and more particularly is not associated with any transceiver 12 and therefore may not receive and/or send communications. In other embodiments, there may not be any wind turbine that is not associated at least with a respective transceiver 12.

FIG. 8 shows a schematic block diagram of control station system 14 in accordance with some embodiments of the currently disclosed subject matter. Any control station system 14 may comprise the following elements: one or more processor(s) 16, one or more memory/ies 18, one or more user input element(s) 20, such as a keypad and/or computer mouse for inputting data to the memory 18, and one or more display element(s) 22 to allow monitoring of the activity of the system(s) installed at the wind farm. For instance, display element(s) 22 may show operational data such as data regarding flying animal(s) whose presence was determined (e.g. tracking data), data regarding system(s) operation and/or status, data regarding potential collision(s) between flying animal(s) and wind turbine(s), data regarding actual collision(s) between flying animal(s) and wind turbine(s), data regarding operation of monitoring element(s) 6 and/or deterrence element(s) 7, etc. Control station 14 may communicate with transceiver(s) 12 of the system(s) at the wind farm (e.g. system(s) 2 and/or 3) by means of one or more transceiver(s) 24. For simplicity's sake, processor 16, memory 18, transceiver 24 in a single control system 14 are generally referred to herein in the single form, but usage of the single form for any particular element should be understood to include embodiments where there is one of the particular element in a single control system 14 and/or embodiments where there is a plurality of the particular element in a single control system 14. As mentioned above, communication among transceivers 12 and 24 may be in any appropriate manner, such as radiofrequency (RF) communication channel, for example using a MESH protocol, and/or for example via cellular, optical fiber, satellite, etc.

Processor 16 may be, for instance, any type of processor such as a digital signal processor (DSP), a central processing unit (CPU), a microcontroller, a field programmable gate array (FPGA), an application specific integrated circuit (ASIC), etc. Memory 18 may or may not store program code, for instance depending on the processor. Additionally or alternatively, memory 10 may, for instance, store other data, for the short and/or long term. In some embodiments, any of processor 16 memory 18, input element(s) 20 and/or display element(s) 22 may be comprised in and/or associated with a computer, but in other embodiments this may not necessarily be so. In some embodiments, at least part of system 14 may be specially constructed for the desired purposes.

Depending on the embodiment, at least part of control system 14 may be located at a wind farm and/or may be located at one or more different location(s). Depending on the embodiment, any control system 14 may supervise one or more wind farms. In some embodiments, control system 14 may be configured to receive operational data from one or more systems 2 and/or 3. In some other embodiments, control system 14 may be configured to receive data from one or more systems 2 and/or 3 and may also be configured to transmit data (e.g. commands, updated program code, updated operational parameters such as frequency/ies, wavelength(s), and/or intensity/ies, updated random modulation, etc) to one or more systems 2 and/or 3. In these latter embodiments, for example, control system 14 may be configured to transmit command(s) such as “do self test”, “offload data in memory to control system”, “update program code in memory”, “activate deterrence element(s)”, “slow down blade rotation”, “halt blade rotation”, etc., although in another example control system 14 may not be configured to transmit all of the above-listed commands. For instance the command to slow down and/or halt blade rotation may be in response to a request for permission to slow down and/or halt blade rotation or may be based on an independent determination by control system 14 (e.g. processor(s) 16) relying on received operational data, that the probability of collision is above a predetermined threshold. In this instance, any processor(s) 8 which receives such a command may then indicate to perform at least one of slowdown or halt of blade rotation.

Depending on the embodiment, system 14 may or may not be a system for detecting and deterring flying animal(s) from a wind farm. In embodiments where system 14 may be a system for detecting and deterring flying animal(s) from a wind farm, processor 16 may independently or in cooperation with one or more system(s) 2 and/or 14 perform one or more functions described herein, for instance as described with respect to method 500.

Optionally, there may be one or more higher level control systems which supervise one or more control systems 14. For instance, a higher level control system may be associated with a manufacturer of system 2 and/or 3 or a part thereof. The higher level control system may, for instance, communicate with any control system 14 via the Internet and/or in any appropriate manner. The higher level control system may or may not be able to communicate directly with any system 2 and/or 3. For instance in some cases any communication with any system 2 and/or 3 may be via control system 14. For example, the higher level control system may receive data regarding operation of one or more systems 2 and/or 3. Based on these field data, the higher level control system may be able to determine how system 2 and/or 3 or a part thereof should operate in the future, for instance may be able to update program code, update operational parameters such as frequency/ies, wavelength(s), intensity/ies, update random modulation rate, etc. In some other embodiments, there may not be a higher level control system and/or control system 14 may itself be configured to determine how any system 2 and/or 3 or a part thereof should operate in the future for instance, configured to update program code, update operational parameters such as frequency/ies, wavelength(s), intensities, update random modulation, etc.

Alternatively to any system embodiments shown in the figures, any of system(s) 2, 3, and/or 14 may in some embodiments include fewer, more and/or different elements than shown in the figures. Alternatively to any system embodiments shown in the figures, the functionality of any of system(s) 2, 3, and/or 14 may in some embodiments be divided differently among the illustrated elements. Alternatively to any system embodiments shown in the figures, the functionality of any of system(s) 2, 3, and/or 14 described herein may in some embodiments be divided into fewer, more and/or different elements than shown in the figures. Alternatively to any of the system embodiments described herein, any of system(s) 2, 3, 14 and/or higher level system(s) may in some embodiments include additional, less, and/or different functionality than described herein.

It will also be understood that the subject matter contemplates that in some embodiments a system or a part of a system disclosed herein may be at least partly comprised in a computer. Likewise, the subject matter contemplates, for example, a computer program being readable by a computer for executing a method or part of a method disclosed herein. Further contemplated by the subject matter, for example, is a computer-readable medium tangibly embodying program code readable by a computer for executing a method or part of a method disclosed herein.

While examples of the subject matter have been shown and described, the subject matter is not thus limited. Numerous modifications, changes and improvements within the scope of the subject matter will now occur to the reader.

1. A system for detecting and deterring one or more flying animals from a wind farm, the system comprising at least one processor capable of:
analyzing signals generated by one or more monitoring elements which monitor a monitored area, and determining that at least one flying animal to be deterred is present in the monitored area;
activating one or more deterrence elements; and
indicating to perform at least one of slowdown or halt of blade rotation of one or more wind turbines if probability of collision between the one or more wind turbines and one or more of the at least one flying animal is above a predetermined threshold.

2. The system of claim 1, further comprising at least one memory storing program code including:
program code for causing one or more of the at least one processor to analyze signals generated by one or more monitoring elements which monitor a monitored area, and for causing the at least one processor to determine that at least one flying animal to be deterred is present in the monitored area;
program code for causing one or more of the at least one processor to activate one or more deterrence elements; and
program code for causing one or more of the at least one processor to indicate to perform at least one of slowdown or halt of blade rotation of one or more wind turbines if a probability of collision between the one or more wind turbines and one or more of the at least one flying animal is above a predetermined threshold.

3. The system of claim 1, further comprising: one or more monitoring elements capable of monitoring a monitored area and generating signals for analysis.

4. The system of claim 3, wherein the one or more monitoring elements comprises any one or more of a CCD camera, a thermal imaging camera and radar.

5. The system of claim 3, wherein monitoring is based on one or more layers.

6. The system of claim 1, further comprising: one or more deterrence elements, wherein each deterrence element is capable of generating or reflecting electromagnetic or pressure waves.

7. The system of claim 6, wherein at least one of the one or more deterrence elements operates in pulses, and wherein one or more of the at least one processor is capable of selecting for pulses of a deterrence element a frequency that is constant, that changes randomly, that is synchronized with blade rotation, or changes in a predetermined sequence.

8. The system of claim 6, wherein at least one of the one or more deterrence elements is capable of generating or reflecting electromagnetic or pressure waves independently of determination that at least one flying animal to be deterred is present in the monitored area.

9. The system of claim 6, wherein at least one of the one or more deterrence elements comprises at least one of: one or more Light Emitting Diodes, LEDs, placed along one or more wind turbines on at least one of tower, blades, hub, or nacelle, or one or more LEDs placed around at least one or more wind turbines.

10. The system of claim 9, wherein the LEDs are embedded in a transparent coating on the surface of the blades.

11. The system of claim 10, wherein the coating is made from polymethyl metacrilate (PMMA) or another transparent material.

12. The system of claim 6, wherein said one or more deterrence elements include at least one selected from a group comprising: LED, optic fiber, reflecting layer, light emitting color, transducer, or loudspeaker.

13. The system of claim 6, wherein for at least one of the one or more deterrence elements, one or more of the at least one processor is capable of selecting at least one of wavelength, wavelengths, frequency, frequencies, intensity, or intensities based on one or more of the least one flying animal.

14. The system of claim 6, wherein deterrence is based on one or more layers.

15. The system of claim 6, wherein there is a plurality of said one or more deterrence elements and wherein electromagnetic energy by at least part of said plurality of deterrence elements produces a predetermined tempo-spatial pattern of lights displayed on blades, tower, nacelle or any other part of one or more wind turbines.

16. The system of claim 15, wherein the predetermined tempo-spatial pattern is an advertisement or decoration, or a part thereof.

17. The system of claim 1, further comprising: one or more controllers capable of slowing down blade rotation or bringing the blades to full halt, upon indication by one or more of the at least one processor.

18. The system of claim 1, wherein blade rotation is slowed down by changing the pitch of the blades.

19. The system of claim 1, wherein blade rotation is slowed down or halted by activating turbine brakes.

20. The system of claim 1, wherein one or more of the at least one processor is further capable of tracking movement of one or more of the at least one flying animal.

21. The system of claim 1, further comprising: at least one transceiver.

22. The system of claim 21, wherein one or more of at least one processor is capable of communicating via one or more of the at least one transceiver with at least one other system at the wind farm.

23. The system of claim 22, wherein said capable of activating includes: one or more of the at least one processor capable of indicating to activate at least one deterrence element included in one or more of the at least one other system at the wind farm.

24. The system of claim 22, wherein said capable of indicating includes: one or more of the at least one processor capable of indicating to perform at least one of slowdown or halt of blade rotation of at least one other wind turbine associated with one or more of the at least one other system at the wind farm.

25. The system of claim 22, wherein communication is via a radio frequency channel using a MESH protocol.

26. The system of claim 21, wherein one or more of the at least one processor is capable of communicating with at least one control system.

27. The system of claim 1, wherein deterrence elements associated with two or more wind turbines are activated simultaneously when presence of one or more flying animals is determined.

28. The system of claim 1, wherein the system or a part thereof is adapted to obtain electrical power from at least one of wind turbine electricity, a dynamo component that generates electricity from rotation of the blades, an electric charger that generates electricity from movement of the rotating blades, or a solar panel.

29. A system for deterring flying animals from a wind turbine, comprising:
a plurality of deterrence elements, each capable of generating or reflecting electromagnetic energy, wherein the electromagnetic energy from the deterrence elements produces a predetermined tempo-spatial pattern of lights displayed on or near the wind turbine.

30. The system of claim 29, further comprising: at least one acoustic deterrence element, each capable of generating sound, wherein the tempo-spatial pattern includes sound.

31. The system of claim 29, wherein said tempo-spatial pattern is displayed upon determination of a presence in a monitored area of one or more flying animals to be deterred.

32. The system of claim 29, wherein said tempo-spatial pattern is displayed independently of determination of a presence in a monitored area of one or more flying animals to be deterred.

33. The system of claim 29, wherein said tempo-spatial pattern is an advertisement or decoration, or a part thereof

34. The system of claim 29, wherein at least one of the deterrence elements operates in pulses with a frequency synchronized with a blade rotation rate.

35. A method of detecting and deterring one or more flying animals from a wind farm, comprising:
analyzing signals generated by one or more monitoring elements which monitor a monitored area, and determining that at least one flying animal to be deterred is present in the monitored area ;
activating one or more deterrence elements; and
indicating to perform at least one of slowdown or halt of blade rotation of one or more wind turbines if a probability of collision between the one or more wind turbines and one or more of the at least one flying animal is above a predetermined threshold.

36. The method of claim 35, further comprising: monitoring a monitored area and generating signals for analysis.

37. The method of claim 35, further comprising: generating or reflecting electromagnetic or pressure waves.

38. The method of claim 35, further comprising: selecting at least one of wavelength, wavelengths, frequency, frequencies, intensity, or intensities, for at least one of the one or more deterrence elements, based on one or more of the at least one flying animal.

39. The method of claim 35, wherein at least one of the one or more deterrence elements operates in pulses, the method further comprising: selecting for pulses of a deterrent element a frequency that is constant, that changes randomly, that is synchronized with blade rotation, or changes in a predetermined sequence.

40. The method of claim 35, further comprising: slowing down or halting blade rotation, upon indication.

41. The method of claim 35, further comprising: tracking movement of one or more of the at least one flying animal.

42. A method of deterring flying animals from a wind turbine, comprising:
providing a plurality of deterrence elements, each capable of generating or reflecting electromagnetic energy, wherein the electromagnetic energy from the deterrence elements produces a predetermined tempo-spatial pattern of lights displayed on or near the wind turbine.

43. A computer program product comprising a computer readable medium having computer readable program code embodied therein for detecting and deterring one or more flying animals from a wind farm, the computer program product comprising:
computer readable program code for causing the computer to analyze signals generated by one or more monitoring elements which monitor a monitored area, and to determine that at least one flying animal to be deterred is present in the monitored area;
computer readable program code for causing the computer to activate one or more deterrence elements; and
computer readable program code for causing the computer to indicate to perform at least one of slowdown or halt of blade rotation of one or more wind turbines if a probability of collision between the one or more wind turbines and one or more of the at least one flying animal is above a predetermined threshold.

44. The computer program product of claim 43, further comprising at least one selected from a group comprising:
computer readable program code for causing the computer to select at least one of wavelength, wavelengths, frequency, frequencies, intensity, or intensities, for at least one of the one or more deterrence elements, based on one or more of the at least one flying animal;
computer readable program code for causing the computer to select for pulses of at any one of the one or more deterrence elements, a frequency that is constant, that changes randomly, that is synchronized with blade rotation, or changes in a predetermined sequence; or
computer readable program code for causing the computer to track movement of one or more of the at least one flying animal.
